(19) United States
(12) Patent Application Publication
(10) Pub. No.: US 2005/0066777 A1
(43) Pub. Date: Mar. 31, 2005

(54) Socket and ratcheting wrench of rotary shape

(76) Inventor: Daniel Lee, Tali City (TW)

Correspondence Address: CHARLES E. BAXLEY, ESQUIRE, Third Floor, 90 John Street, New York, NY, 10038, US

(21) Appl. No.: 10/671,757

(22) Filed: Sep. 26, 2003

(51) Int. Cl. B25B 13/46

(52) U.S. Cl. 81/60

(57) ABSTRACT

A socket and ratcheting wrench of rotary shape generally includes a wrench body, an annular-toothed block and a socket, wherein the annular-toothed block is rotatably disposed in the wrench body, and the annular-toothed block is defined with a through engaging hole, on the inner peripheral wall of the engaging hole a plurality of ribs are formed thereon, each paired neighboring ribs are connected by an negative arc surface, each rib is provided with a flat first engaging surface at both sides thereof, between the first engaging surfaces is defined with a cambered second engaging surface, the first engaging surface is connected with the second engaging surface by an arc surface. The socket has a first end provided with a plurality of grooves and has a second end defined with polygonal faces at its outer periphery. Both the first and the second end can be engaged with the wrench body of the ratcheting wrench of rotary shape, by this way, by changing the engagement of the socket with the ratcheting wrench of rotary shape, the ratcheting wrench of rotary shape is not only applicable to different sockets but also capable of directly driving polygonal fasteners.

### BACKGROUND OF THE INVENTION

1. Field of the Invention

The present invention relates to a socket and ratcheting wrench of rotary shape, and more particularly to a ratcheting wrench of rotary shape that is not only applicable to different structured sockets but also capable of driving polygonal fasteners independently.

2. Description of the Prior Arts

A ratchet wrench and a socket of prior arts as shown in FIG. 1, which generally includes a head portion 11 connected with a wrench body 10, in the head portion 11 is defined with a ratchet 12. At the center of the ratchet 12 a through engaging hole 13 is formed, the engaging hole 13 is defined at its inner periphery with positive arc ribs 131. Furthermore, an engaging hole 21 with predetermined shape is formed in the socket 20 for engaging with fasteners (such as screw, nut), on the outer periphery of the socket 20 is formed with negative arc-formed grooves 22 for engaging with the respective ribs 131 of the ratchet 12. The socket 20 can be driven by the wrench body 10 so as to achieve a screwing and unscrewing operation. However, there are still some disadvantages of this conventional ratchet wrench as follows needs to be improved:

First, the respective ribs 131 on the ratchet 12 are positive arc formed, the grooves 22 of the socket 20 must be negative arc-formed so as to engage with the ribs 131, in this case, the ratchet wrench provided with positive arc-formed ribs 131 can only be matched with the socket 20 defined with negative arc-formed grooves 22, thereby the applicability of the conventional ratchet wrench is limited.

Second, when the ratchet wrench provided with ribs 131 are used to engage directly with a fastener 30, due to the head of the fastener 30 is usually polygonal-shaped (such as hexagonal or octagonal-shape), and the respective ribs 131 are employed to engage with the sides respective sides of the fastener 30, the ribs 131 are line-contacted with the sides of the fastener 30, in this case, it may be allow the possibility of the jaw of the wrench falling open during use. This conventional ratchet wrench is only able to drive the fastener 30 with its engaging hole 13, thus the applicability is limited.

The present invention has arisen to mitigate and/or obviate the afore-described disadvantages of the conventional ratchet wrench.

### SUMMARY OF THE INVENTION

The primary object of the present invention is to provide a socket and ratcheting wrench of rotary shape, wherein the ratchet wrench is applicable to different shaped sockets.

Another object of the present invention is to provide a socket and ratcheting wrench of rotary shape, wherein the ratchet wrench is capable of driving polygonal fasteners.

The present invention will become more obvious from the following description when taken in connection with the accompanying drawings, which shows, for purpose of illustrations only, the preferred embodiment in accordance with the present invention.

### BRIEF DESCRIPTION OF THE DRAWINGS

FIG. 1 is plan view of a conventional socket and ratchet wrench;

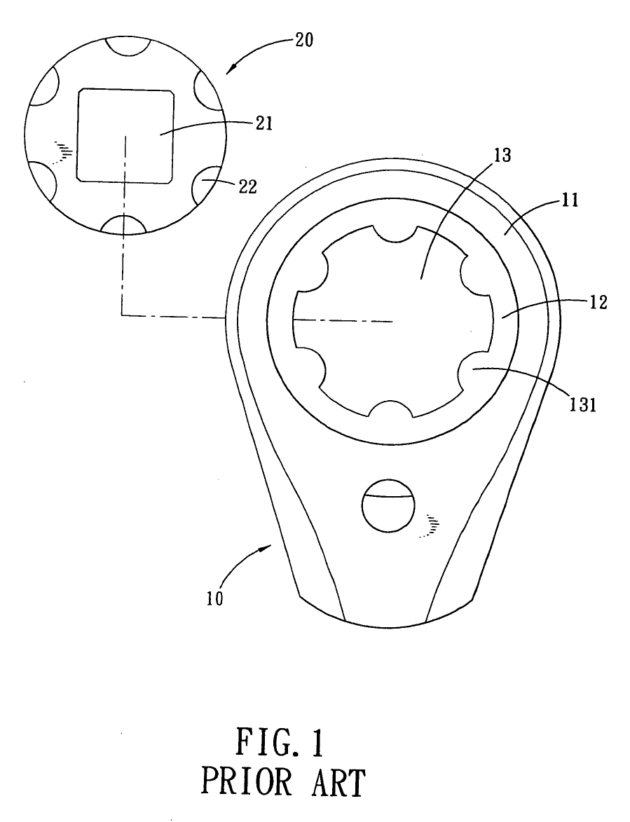

FIG. 2 is another plan view of a conventional socket and ratchet wrench;

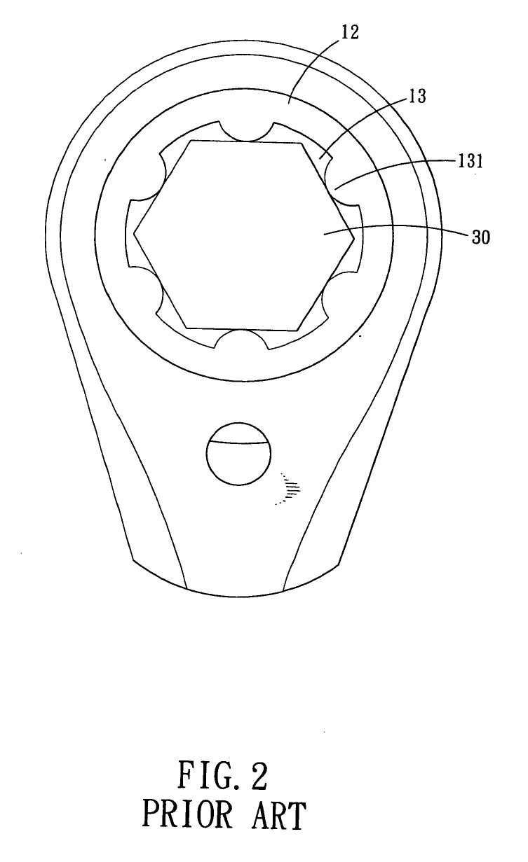

FIG. 3 is an exploded view of a socket and ratcheting wrench of rotary shape of the present invention;

FIG. 4 is a perspective assembly view of the socket and ratcheting wrench of rotary shape of the present invention;

FIG. 5 is a top view of the socket and ratcheting wrench of rotary shape of the present invention, wherein the ratchet engages with a first end of the socket;

FIG. 6 is a partial amplified view of FIG. 5;

FIG. 7 is a top view of the socket and ratcheting wrench of rotary shape of the present invention, wherein the ratchet engages with a second end of the socket;

FIG. 8 is a partial amplified view of FIG. 7.

### DETAILED DESCRIPTION OF THE PREFERRED EMBODIMENT

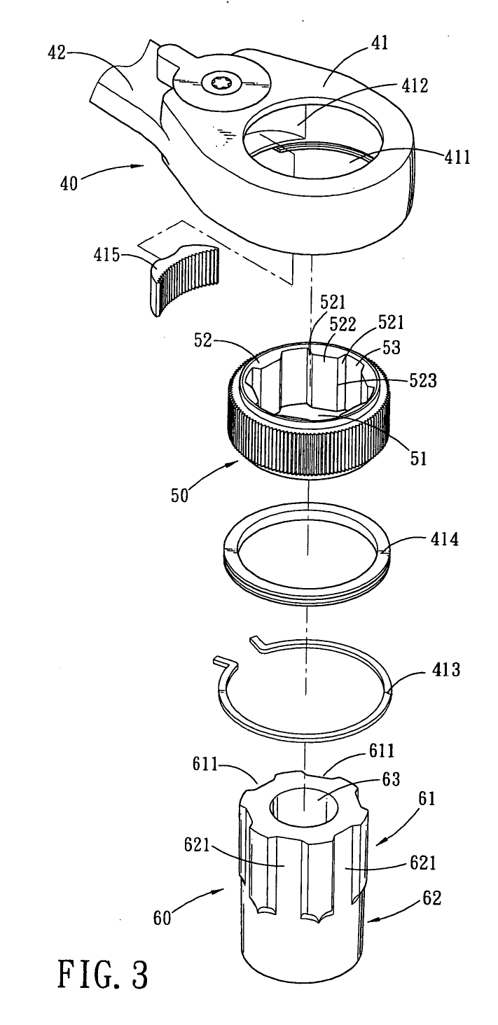

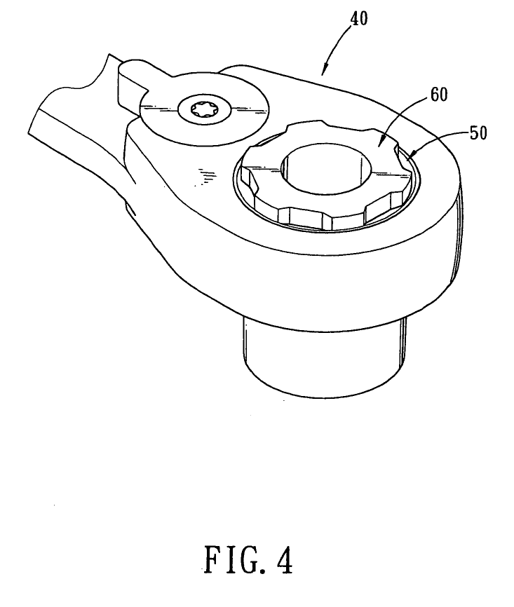

Referring to FIGS. 3-4, a socket and ratcheting wrench of rotary shape of the present invention generally comprises a wrench body 40, an annular-toothed block 50 and a socket 60.

The wrench body 40 has a head portion 41 and a handle portion 42. In the proximity to the center of the head portion 41 is defined with a receiving hole 411 and a recess 412. The recess 412 is connected with the receiving hole 411. On the inner periphery of the receiving hole 411 is provided with an elastic C-shaped ring 413 and a ring 414, whereas in the recess 412 a locking block 415 is received. The handle portion 42 serves for user's gripping.

The annular-toothed block 50, via the elastic C-shaped ring 413, the ring 414 and the locking block 415, is rotatably received in the receiving hole 411 of the wrench body 40. The annular-toothed block 50 is defined with a through engaging hole 51, on the inner periphery of the engaging hole 51 six ribs 52 are defined, each paired neighboring ribs 52 are connected by a negative arc surface 53, at both sides of each rib 52 is respectively provided with a flat first engaging surface 521, between the first engaging surfaces 521 of the respective ribs 52 a cambered second engaging surface 522 is defined. The first engaging surface 521 is connected to the second engaging surface 522 via an arc surface 523.

The socket 60 has a first end 61 and a second end 62. The socket 60 attenuates gradually from the first end 61 to the second end 62. Wherein on the outer periphery of the first end 61 six grooves 611 are defined for engaging with the respective ribs 52 of the annular-toothed block 50. The second end 62 is provided on its outer periphery with six planes 621 for engaging with the second engaging surfaces 522 of the respective ribs 52 of the annular-toothed block 50. Furthermore, the socket 60 is defined with a through engaging hole 63 for engaging with fasteners to be operated.

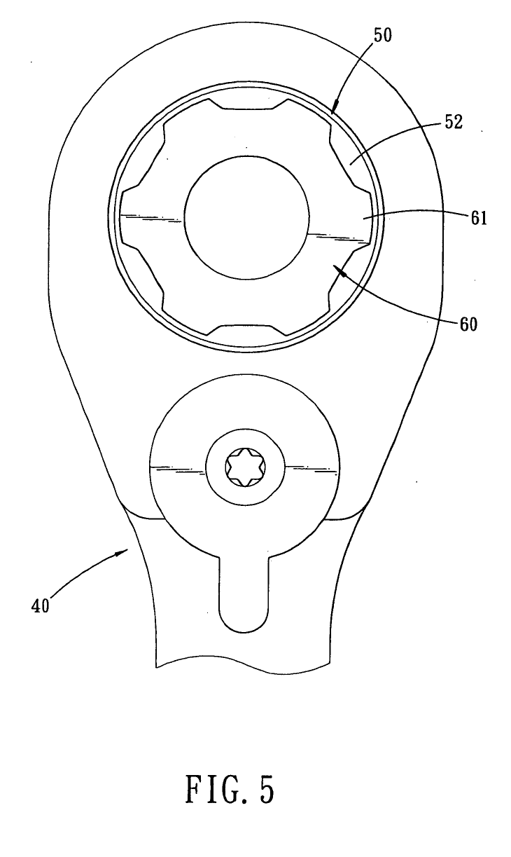

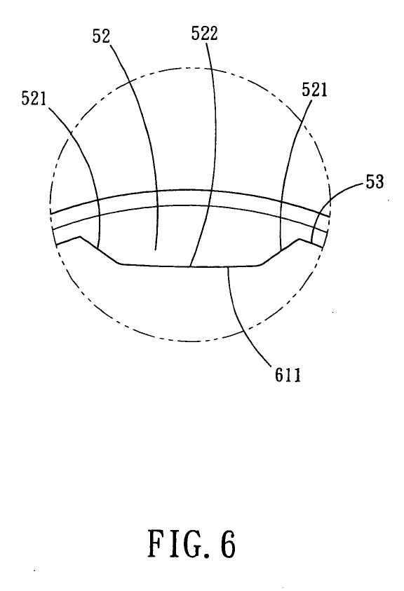

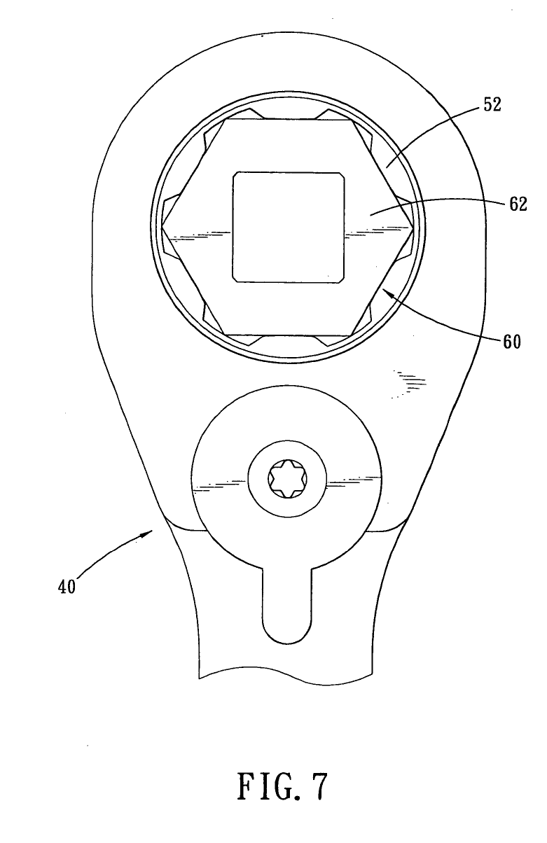

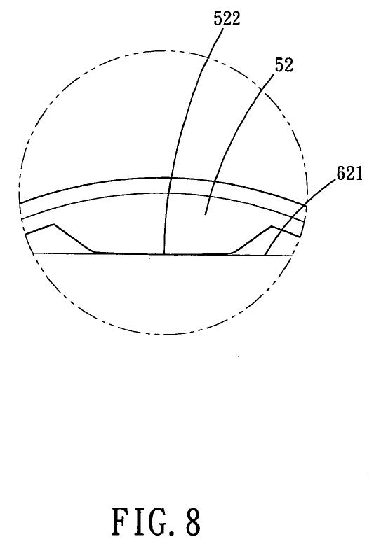

Referring to FIGS. 5-6, in which, when the wrench body 40 engages with the first end 61 of the socket 60, the first engaging surface 521, the second surface 522 and the negative arc surface 53 of the respective ribs 52 of the annular-toothed block 50 will engage in the respective grooves 611 of the socket 60, such that ratcheting wrench of rotary shape is able to drive the socket 60 to accomplish an screwing or unscrewing operation on fasteners. With reference to FIGS. 7-8, wherein the wrench body 40 also can engage with the second end 62 of the socket 60, the second engaging surfaces 62 of the respective ribs 52 of the annular-toothed block 50 are employed to engage with the respective planes 621 of the socket 60, so that the socket 60 is driven by the ratcheting wrench of rotary shape. Thus, the socket 60 can engage bi-directionally with the ratcheting wrench of rotary shape of the present invention. By this way, the ratcheting wrench of rotary shape of the present invention is capable of engaging with two different shaped sockets, so as to improve the applicability.

In addition, since the ratcheting wrench of rotary shape can engage with the socket 60 which having a hexagonal cross section, which can be used to independently engage with the fasters having a hexagonal cross section, so as to accomplish a screwing or unscrewing operation, and thus further improves the applicability of the ratcheting wrench of rotary shape of the present invention.

While we have shown and described various embodiments in accordance with the present invention, it should be clear to those skilled in the art that further embodiments may be made without departing from the scope of the present invention.

1. A socket and ratcheting wrench of rotary shape comprising:
a wrench body having a head portion and a handle portion, on the head portion defined with a receiving hole, the handle portion serving for gripping;
an annular-toothed block rotatably received in the receiving hole of the wrench body, the annular-toothed block defined with a through engaging hole, on the inner periphery of the engaging hole multiple ribs defined, each paired neighboring ribs connected by a negative arc surface, at both sides of each rib respectively provided with a flat first engaging surface, between the first engaging surfaces of the respective ribs a cambered second engaging surface defined thereof, the first engaging surface, via an arc surface, connected to the second engaging surface;
a socket having a first end and a second end, on the outer periphery of the first end multiple grooves defined for engaging with the respective ribs of the annular-toothed block, the second end provided on its outer periphery with multiple planes for engaging with the second engaging surfaces of the respective ribs.

2. The socket and ratcheting wrench of rotary shape as claimed in claim 1, wherein the socket attenuates gradually from the first end to the second end.
